(19) United States
(12) Patent Application Publication
(10) Pub. No.: US 2024/0410592 A1
(43) Pub. Date: Dec. 12, 2024

(54) FUME EXTRACTION DEVICE FOR A HOB

(71) Applicant: ELECTROLUX APPLIANCES AKTIEBOLAG, Stockholm (SE)

(72) Inventors: Peter NEGRETTI, Forli (IT); Nicola VALPIANI, Forli (IT); Songliang CHEN, Forli (IT); Milka BEKJAROVA, Forli (IT); Ines RADHIMA, Forli (IT)

(21) Appl. No.: 18/702,086

(22) PCT Filed: Oct. 18, 2022
(86) PCT No.: PCT/EP2022/078938

§ 371 Date: Apr. 17, 2024

(30) Foreign Application Priority Data
Oct. 19, 2021 (EP) 21203459.9

(51) Int. Cl. F24C 15/20

(52) U.S. Cl. CPC F24C 15/2021; F24C 15/2042

(57) ABSTRACT

The present invention relates to a fume extraction device (1) for a hob (2) with at least one cooking unit (2.1), wherein the fume extraction device (1) comprises a blower unit (10), wherein the blower unit (10) is configured for being variably controlled by means of or in response to at least one control signal(S), wherein the fume extraction device (1) is connected to or communicates with or comprises a sensor system (20) with at least one sensor unit (22, 23, 24) being configured for detecting at least one parameter (P), wherein the fume extraction device (1) comprises or communicates with a control unit (30), wherein—the control unit (30) is configured for controlling the blower unit (10) via the at least one control signal (S) and to activate and/or deactivate and/or variably control the blower unit (10) in an automatic mode dependent on the detected at least one parameter (P), and/or—the sensor system (20) comprises a motion sensor unit (21) being configured for detecting motion data (MD) of a user, wherein the control unit (30) is configured to activate and/or deactivate and/or variably control the blower unit (10) in the automatic mode dependent on the detected motion data (MD). The present invention relates further to a method of operating a fume extraction device (1) and to a system or a combination apparatus comprising a hob (2) and a fume extraction device (1).

The present invention lies in the field of food preparation and relates to a fume extraction device for a hob with at least one cooking unit, a method of operating a fume extraction device, and a system including a fume extraction device and a hob or a combination apparatus comprising a hob and a fume extraction device.

Fume extraction devices, also labelled as “hoods”, are increasingly used in the kitchen area for the preparation of food in order to extract and eliminate fumes, odors and other undesirable substances contaminating the air.

Fume extraction devices as known from the prior art are inter alia equipped with sensors in order to support the operation of the blower unit of a fume extraction device.

For example, a fume extraction device is described in U.S. Pat. No. 6,920,874 B1. The fume extraction device comprises an electronically controllable fan of variable speed and four air quality sensors for temperature, humidity, carbon monoxide and smoke for detecting hazardous substances in the air. An embedded control algorithm examines the output of the air quality sensors and trend information of measured signals and determines an instantaneous ventilation requirement. A fuzzy logic control algorithm controls the speed of the fan accordingly such that every combination of the conditions of the air quality sensors will have a unique associated fan speed level based on said ventilation requirement. An audible alarm is activated if contaminants in the air are detected that remain at a hazardous level for longer that predetermined time.

Further, a method of adjusting a commercial kitchen exhaust hood is described, for example, in U.S. Pat. No. 9,702,566 B2. The exhaust hood comprises a controller for controlling the hood in accordance with stored operating parameters and a manual override trigger input enables a user to manually trigger a maximum exhaust mode for the hood section. A thermal load monitoring system adjusts the blower, i.e. the exhaust flow based upon monitored thermal load on the basis of at least one temperature sensor for detecting temperature within the exhaust hood section. A VOC monitoring system (VOC is the abbreviation of “Volatile Organic Compound”) with at least one VOC sensor triggers a maximum exhaust mode for the exhaust hood section when sensed VOCs exceed a VOC limit.

The fume extraction devices known from the prior art have the disadvantage, for example, that a comparatively intensive manual input or operation from a user is necessary in order to operate the fume extraction device accordingly, especially in view of rapidly changing environmental conditions.

In addition, for example, the fume extraction devices as known from the prior art are not configured to operate more or less autonomously in certain situation, i.e. independently from a user input.

It is therefore an object of the present invention to provide a fume extraction device with an improved and extended functionality relating to the extraction of fumes and/or to operating conditions of the fume extraction device.

Further, it is an object of the present invention to provide an improved method of operating a fume extraction device that, for example, prevents faulty operation considering the current and/or the expected future air condition and thus the air quality, and safely operates the fume extraction device at least temporarily.

Moreover, it is a further object of the present invention to provide a system including a fume extraction device and a hob or a combination apparatus comprising a hob and a fume extraction device.

The object of the present invention is solved by a fume extraction device according to independent claim 1, by a method for operating a fume extraction device according to independent claim 7 and a system or a combination apparatus according to claim 15.

A first general aspect of the present invention relates to a fume extraction device, which may be configured to draw in cooking fumes generated by cooking activities performed on a hob with at least one cooking unit, wherein the fume extraction device comprises a blower unit, wherein the blower unit is configured for being variably controlled by means of or in response to at least one control signal, wherein the fume extraction device is connected to or communicates with or comprises a sensor system or a sensor arrangement with at least one sensor unit, preferably several sensor units, being configured for detecting at least one parameter, particularly being in connection with or related to the hob, wherein the fume extraction device communicates with or comprises a control unit. According to a first variant, the control unit is configured for controlling the blower unit via the at least one control signal, wherein the control unit is configured to activate and/or deactivate and/or variably control the blower unit in an automatic mode dependent on the detected at least one parameter. According to a second variant, which may be applicable as an alternative or as an addition to the previously mentioned first variant, the sensor system comprises a motion sensor unit, which is configured for detecting motion data of a user, wherein the control unit is configured to activate and/or deactivate and/or variably control the blower unit in the automatic mode dependent on the detected motion data. In particular, said activation and/or deactivation and/or variable control is performable dependent on motion data indicating the user's presence and/or movement in or within a predetermined vicinity of the fume extraction device and/or of the hob. Hence, the invention may also cover the solution of the at least one parameter being or comprising the user's motion data, which means that said motion data or information is the only one parameter being in connection with or related to the hob. This allows, for example, the inclusion and consideration of the presence or absence of a user, preferably during the operation of the fume extraction device and/or the hob and with regard to the further operation of the fume extraction device and/or the hob.

The present invention provides a fume extraction device that is configured, for example, for reliable and more or less autonomous operation such that a user input or intervention by a user becomes unnecessary, at least in the first place. For example, due to an auto-activation in the automatic mode of the fume extraction device, condensation of liquids (water and grease) and/or concentration of generated odours in the air can be avoided or at least effectively or significantly reduced, more specifically in such situations in which the user of cooking appliances misses to activate the fume extraction device when performing cooking processes.

The blower unit of the fume extraction device can be configured to be variably controlled by means of at least one control signal and the control unit can be configured, in dependence on or dependent on the at least one parameter, to execute at least one operation or at least one of the following on the blower unit: activating, deactivating and/or variably controlling. This allows, for example, the provision of a fume extraction device that is characterized by an operating mode in a closed-loop configuration and more or less in an autonomous manner.

The at least one parameter, which may be in connection with or related to the hob, can comprise a parameter of the air being above the hob, preferably during a cooking process at the hob.

It is possible that the control unit can be configured to calculate the at least one control signal for variably controlling the blower unit as a function of the detected at least one parameter and/or as a function of detected user's motion data by means of a motion sensor unit of the sensor system.

Variably controlling can comprise adjusting the rotational speed of a propeller of the blower unit that provides for the suction effect.

Variably controlling allows, for example, a dynamic or time-varying change of the functionality of the blower unit and/or an adaptation of the blower unit to current and/or future air conditions.

The at least one sensor unit can be configured for continuously detecting the at least one parameter at least intermittently or for at least a time period, preferably a predetermined or a calculated time period, and/or may be configured for transforming the detected at least one parameter into at least one parameter signal.

This allows, for example, also a variably operation of the at least one sensor unit of the sensor system.

It is possible that the fume extraction device can be configured for connection with the hob, preferably via a wired signal communication or more preferably via a wireless signal communication, to query operating status data of the at least one cooking unit, wherein the control unit may be configured for controlling the blower unit dependent on the queried operating status data of the at least one cooking unit until the detected at least one parameter reaches a target value or is in a range of target values.

This provides, for example, for consideration of the operating status or operating mode of the hob, preferably the at least one cooking unit.

The fume extraction device can comprise a user interface unit or can be configured for connection with a user interface unit, preferably via a wired signal communication or more preferably via a wireless signal communication, wherein the user interface unit may be configured to at least activate, preferably initially activate, and/or deactivate, preferably finally deactivate, the automatic mode, preferably dependent on operating status data of the blower unit and/or the detected at least one parameter and/or the detected motion data.

Hence, the user can first and foremost activate and also finally deactivate the automatic mode of the fume extraction device conveniently via a user interface unit.

The at least one sensor unit may comprise or be configured as a temperature sensor, a humidity sensor and/or a VOC sensor, preferably a TVOC sensor, each being connected to the control unit.

According to embodiments, the automatic mode is activatable based on detected motion data. Preferably, the automatic mode is activatable based on a plurality of detected motion data. An even more preferable solution may provide for an activation of the automatic mode based on a user's motion profile, which may be interpretable by the control unit as a user's execution of or intention to perform a cooking process. This advanced solution is based on the consideration that a person just walking around in a room, e.g. a kitchen, in which the cooking system or equipment is located, shall not trigger the fumes extraction device to be set into the automatic mode, but in contrast, only a user with an intention to cook shall be allowed or enabled to carry out said activation. That way, any unnecessary activation of the blower unit of the fume extraction device is avoided, what leads to a desired effect of saving energy.

In some implementations, the motion data, which provide a basis for the interpretation of the user's execution of or intention to perform a cooking process, include a user's stay at a distance to the fume extraction device and/or to the hob, wherein the user's distance is lower than a predetermined distance value, and wherein the user's stay is equal to or longer than a predetermined stay time. It may be provided that only if the above-mentioned two conditions are fulfilled, this will be interpreted as a user with a view to or in execution of performing a cooking process.

A second general aspect of the present invention relates to a method of operating a fume extraction device, in particular for drawing in cooking fumes of a hob having at least one cooking unit, preferably a fume extraction device as disclosed herein, wherein the fume extraction device comprises a blower unit, wherein preferably the blower unit is variably controlled by means of or in response to at least one control signal, wherein the fume extraction device is connected to or communicates with or comprises a sensor system with at least one sensor unit being configured for detecting at least one parameter, particularly being in connection with or related to the hob, and wherein the fume extraction device communicates with or comprises a control unit, which controls the blower unit. According to a first variant of the method according to the present invention, the method comprises: detecting the at least one parameter by the at least one sensor unit; variably controlling the blower unit by the control unit via, more specifically in response to, the at least one control signal in an automatic mode dependent on the detected at least one parameter. The control signal may be generated processing said parameter. Specifically, the control of the blower unit is performed or executed in order to achieve a specific threshold, preferably in reasonable time, what may guarantee a favourable balance between power consumption of the entire appliance and its performance. With such means, environmental sustainability could be guaranteed. Favourably, an algorithm is provided for this process. The parameter signal may be considered and validated by the control signal. According to a second variant of the method according to the present invention, which may be applicable as an alternative or as an addition to the previously mentioned first variant, the method further comprises: detecting at least one motion data of a user by a motion sensor unit of the sensor system being configured for detecting the motion data of a user; activating an automatic mode for an automatic control of the fume extraction device and/or variably controlling the blower unit by the control unit via the at least one control signal in the automatic mode dependent on the detected motion data, in particular dependent on motion data indicating the user's presence in a predetermined vicinity of the fume extraction device and/or of the hob.

It is possible that the method further comprises: activating and/or deactivating the blower unit by the control unit, preferably at least when the detected at least one parameter has exceeded or has fallen below a target value, and/or in dependence of a change of the detected at least one parameter and/or in dependence of a change of detected motion data of a user at least over a time period.

The target value may be a predetermined or a calculated target value, and/or the time period can be a predetermined or a calculated time period.

Activating and/or deactivating the blower unit can comprise adjusting the rotational speed of a propeller of the blower unit.

It is possible that the method further comprises: comparing the detected at least one motion data with at least a further detected motion data and/or comparing the detected at least one parameter with at least a further detected at least one parameter; and calculating of a motion deviation indicator of the compared detected at least one motion data and the further detected motion data and/or calculating of a parameter deviation indicator of the compared detected at least one parameter and the further detected at least one parameter.

The method can further comprise: generating at least one control signal dependent on the calculated motion deviation indicator and/or the calculated parameter deviation indicator; and variably controlling the blower unit by the control unit via the generated at least one control signal, preferably in the automatic mode.

According to specific embodiments of the method according to the present invention, the detection of the motion data and/or the detection of the at least one parameter may be monitored, which may be performed at least for a time period and/or until a criterion is met, wherein said monitoring comprises: querying operating status data of the motion sensor unit and/or the at least one sensor unit; sending at least one test signal from the control unit to the motion sensor unit and/or to the at least one sensor unit; and/or returning at least one test signal from the motion sensor unit and/or from the at least one sensor unit to the control unit. It is also possible that the method comprises monitoring the blower unit, for example, via detecting noise generated by the blower unit.

The method can further comprise: validating the detected at least one motion data and/or the detected at least one parameter, preferably with a further detected motion data and/or a further detected at least one parameter; and adapting the at least one control signal dependent on the validated detected motion data and/or the validated detected at least one parameter.

Validating can comprise: comparing the detected at least one motion data and/or the detected at least one parameter with a predefined and/or specified stored motion data and/or at least one parameter of at least one reference operation mode of the fume extraction device.

It is possible that the method comprises: establishing a connection with the hob, preferably via a wired signal communication or more preferably via a wireless signal communication; querying of operating status data of at least one cooking unit of the hob; and generating the at least one control signal dependent on the queried operating status data of the at least one cooking unit.

More specifically, the method comprises: setting the automatic mode dependent on operating status data of the blower unit and/or the detected at least one parameter and/or the detected motion data, in particular following a transmission of at least one control signal from a user interface unit to the control unit.

Moreover, the automatic mode may be activated based on detected motion data. Preferably, said activation is based on a plurality of detected motion data, more preferably based on a user's motion profile. The plurality of detected motion data, more specifically the user's motion profile, may be interpretable by the control unit as a user's execution of or intention to perform a cooking process.

A third general aspect of the present invention relates to a system including a fume extraction device and a hob, or a combination apparatus comprising a hob and a fume extraction device, wherein the fume extraction device, and particularly also the hob, is configured as disclosed herein, and/or wherein the fume extraction device, and particularly also the hob, is configured to be operated by a method as disclosed herein. The fume extraction device may be preferably integrated at least partially into the hob or arranged opposite the hob and/or arranged at a distance from the hob, preferably arranged laterally next to the hob.

In particular, the automatic mode is only activated or activatable following or in dependency of a touch or activation of a key or control element of the fume extraction device or of the hob. This may be a further step for avoiding any unnecessary activation of the blower unit of the fume extraction device, i.e. leading to a desired effect of saving energy, because with a user touching the hob or the fume extraction in any way an intention of starting or performing a cooking process is even further indicated.

In order to avoid repetition, features which are directed to the method according to the present invention and/or disclosed in connection therewith should also be considered as disclosed according to the fume extraction device and be claimable and vice versa.

The previously described examples and features of the present invention can be combined with each other in any way.

Further or other details and advantageous effects of the present invention are described in more detail below with reference to the attached figures:

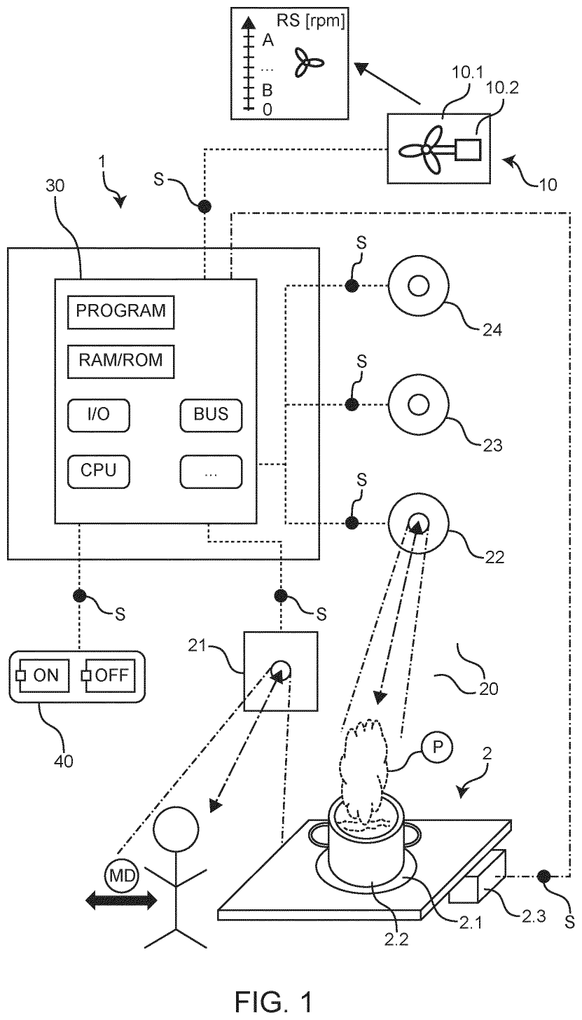

FIG. 1 illustrates schematically an arrangement of a hob and an example of a fume extraction device according to the present invention;

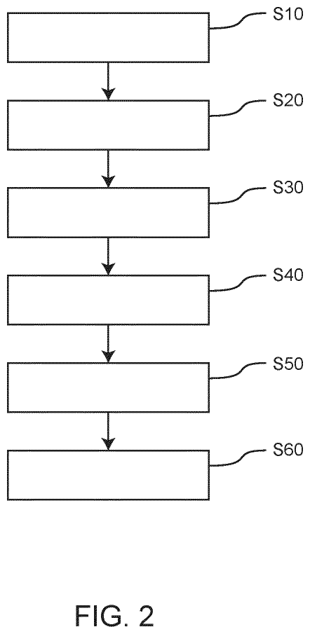

FIG. 2 illustrates a flowchart of a first example of the method according to the invention;

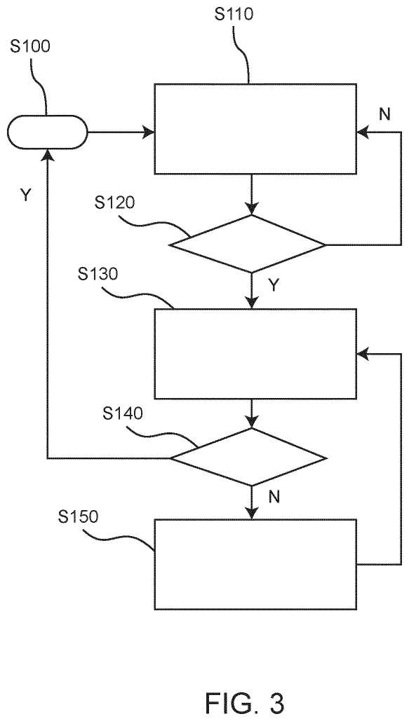

FIG. 3 illustrates a flowchart of a second example of the method according to the invention; and

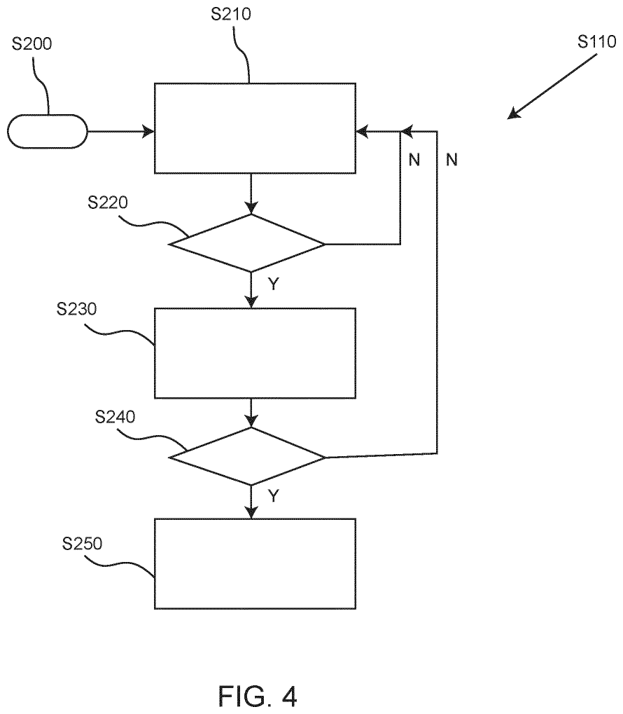

FIG. 4 illustrates a flowchart of an initial step of the flowchart according to FIG. 3.

Identical or functionally equivalent components or elements are marked or labeled in the figures with the same reference signs. For their explanation, reference is also made to the description of other examples and/or figures in order to avoid repetition.

The following detailed description of the examples shown in the figures serves as a closer illustration or exemplification and is in no way intended to limit the scope of the present invention.

FIG. 1 illustrates schematically an arrangement of a hob 2 and an example of a fume extraction device 1 according to the present invention.

The hob 2 can be, for example, a hob 2 as known from the prior art. The hob 2 can comprise at least one cooking unit 2.1. The at least one cooking unit 2.1 can be preferably configured as an induction cooking unit 2.1 comprising at least an induction coil and a power board (not shown in FIG. 1 for reasons of clarity). Alternatively, the at least one cooking unit 2.1 can be configured differently with regard to the principle of generating heat, for example, as heating coils, gas burners or the like. It is possible that the hob 2 comprises a plurality of cooking units 2.1, for example four cooking units 2.1.

As regards the illustration in FIG. 1, a pot or a vessel 2.2 with food to be prepared is placed on the at least one cooking unit 2.1. The at least one cooking unit 2.1 is illustrated in an operating mode of corresponding operating status according to which the food inside the vessel 2.2 is heated by the at least one cooking unit 2.1.

As a consequence of the cooking process and the heat treatment of the food in the vessel 2.2 via the at least one cooking unit 2.1, fumes with grease and/or odours and/or smallest particles are generated, which contaminate the surrounding air and negatively affect the quality of the air, at least in the area of the hob 2.

In order to remove fumes from the air again and to restore air quality, a fume extraction device 1 according to the present invention is provided.

Similar to the illustration of the hob 2, the example of the fume extraction device 1 of the present invention is illustrated schematically and will be described in further detail. Here, as with the hob 2, the most important components and elements, at least those relevant to the exemplary description of an example of the fume extraction device 1, are described. It is understood that the fume extraction device 1 naturally includes further components and elements such as grease filter elements, odour filter elements, flow channels, a protective grille, an air intake opening or the like.

The fume extraction device 1 according to the present invention is configured or adapted for the hob 2 with the at least one cooking unit 2.1.

As illustrated in FIG. 1, the fume extraction device 1 is arranged spatially separated from the hob 2. The fume extraction device 1 with an air intake unit (not illustrated in FIG. 1 for the sake of clarity) is preferably arranged opposite and/or at a distance from the hob 2, i.e. the at least one cooking unit 2.1. Alternatively, it is possible that the fume extraction device 1 is arranged laterally next to the hob 2 or opposite and/or at a distance from the hob 2. It is also possible as a further alternative that the fume extraction device 1 is at least partially integrated into the hob 2 and formed as a so-called “downdraft” fume extraction device 1.

The fume extraction device 1 comprises a blower unit 10. The blower unit 10 comprises a propeller 10.1 that provides for a suction effect for extracting fumes from the hob 2. The blower unit 10 of the fume extraction device 1 of the present invention is configured for variably controlling via at least one control signal S. In other words, the blower unit 10 is configured to be variably controlled by means of at least one control signal S, for example, via an interface (not illustrated in FIG. 1 for the sake of clarity). In order to realize such configuration of the blower unit 10, the blower unit 10 can preferably comprise an adjustable or variably controllable electric motor 10.2, such as a brushless DC motor, for driving the propeller 10.1 at corresponding rotational speed [rpm]. The blower unit 10 may further comprise own power electronics (not illustrated in FIG. 1 for the sake of clarity) in the form of a circuit board or a power board for variably controlling the motor 10.2. The circuit board or the power board may include or may be connected to an interface.

The fume extraction device 1 according to the present invention further comprises a sensor system 20 in the form of a sensor arrangement 20. The sensor system 20 comprises at least one sensor unit 22, 23, 24 being configured for detecting at least one parameter P being at least in connection with the hob 2 or being at least related to the hob 2. The at least one sensor unit 22, 23, 24 can be preferably at least one parameter sensor unit 22, 23, 24. In detail, the sensor system 20 of the illustrated example of the fume extraction device 1 comprises a sensor unit 22, which includes or is configured as a temperature sensor 22, a sensor unit 23, which includes or is configured as a humidity sensor 23, and a sensor unit 24, which includes or is configured as a VOC sensor 24. As described above, the term “VOC” is an abbreviation for “Volatile Organic Compound”. It is possible that the VOC sensor 24 may be preferably configured as a TVOC sensor 24 according to which the term “TVOC” is an abbreviation for “Total Volatile Organic Compound” as known from the prior art.

Each of the sensor units 22, 23, 24 may be configured for detecting at least one parameter P. As described above, the at least one parameter P may be at least in connection with the hob 2 or at least related to the hob 2 and may preferably comprise a detectable and/or measurable physical quantity and/or property.

The three sensors 22, 23, 24 of the present example of the fume extraction device 1 are configured for detecting each a different parameter P relating to the hob 2. In detail, the temperature sensor 22 is configured for detecting a temperature in the proximity of the at least one cooking unit 2.1 and/or preferably in at least the area above the vessel 2.2 as a temperature parameter P. The humidity sensor 23 may be configured for detecting a humidity in the proximity of the at least one cooking unit 2.1 and/or preferably in at least the area above the vessel 2.2. The VOC sensor 24 may be configured for detecting subtle changes in the air regarding or focusing, for example, specific compounds or concentration of compounds as parameter P. For example, the VOC sensor 24 may be configured as a photoionization detector (“PID”) using ultraviolet light to identify VOCs. Hence, the at least one sensor unit 22, 23, 24 may comprise or may be configured as an optical sensor.

Each of the sensor units 22, 23, 24 or sensors 22, 23, 24 can be configured for continuously and/or intermittently detecting the respective at least one parameter P, for at least a time period, preferably a predetermined or a calculated time period. The sensor units 22, 23, 24 or sensors 22, 23, 24 may each comprise an interface and a circuit board or a power board (not illustrated in FIG. 1 for the sake of clarity) for transmission and/or processing of signals S representing or containing, for example, information related to the respective parameter P and/or information relating to controlling of the sensor unit 22, 23, 24 or sensor 22, 23, 24.

The sensor units 22, 23 and 24 may be configured for transforming the detected at least one parameter P into at least one parameter signal S, the at least one parameter signal S representing a temperature value or preferably a plurality of temperature values detected over a predetermined time period may, for example, be normalized to a reference value in order to be at least comparable and processable by the control unit 30 with at least a further at least one parameter signal S representing, for example, a humidity value or preferably a plurality of humidity values detected over a predetermined time period and normalized to a reference value, accordingly.

It is also possible that one single sensor unit 22, 23, 24 comprises at least two sensors such as a humidity sensor 23 and a VOC sensor 24 and thus a combination of sensors in one single unit.

In addition, the sensor system 20 may comprise a motion sensor 21. The motion sensor 21 is configured for detecting motion data MD of a user (see illustration in FIG. 1). The motion sensor 21 may be a motion sensor 21 as known from the prior art and may be able to detect at least the presence of a user in front of the hob 2 and/or in the proximity of the fume extraction device 1. Similar to the sensor units 22, 23, and 24, the motion sensor unit 21 may comprise an interface and a circuit board or a power board (not illustrated in FIG. 1 for the sake of clarity) for transmission and/or processing of signals S representing or containing, for example, information related to the presence or absence of a user, i.e. motion data MD. It is possible that the motion sensor 21 may comprise or may be configured as an infrared sensor. The motion sensor unit 21 may further be configured for detecting a plurality of a user's motion data, more specifically a user's motion profile, particularly when moving around or when staying in a close distance to the motion sensor unit 21, or the hob 2 or the fume extraction device 1, respectively, in order to allow an interpretation of the user's current motivation. For example, according to a first variant, the user may just walk around for a simple stay in a vicinity to the cooking equipment 1, 2, or, according to a second variant, the user may approach the cooking equipment 1, 2 with an intent to perform a cooking process.

The fume extraction device 1 according to the present invention further comprises a control unit 30. The control unit 30 may preferably comprise at least one central processing unit (“CPU”) such as microcontroller, storage devices in the form of volatile and/or non-volatile storage device such as a RAM device (abbreviation for “Random-Access Memory”) and/or a ROM device (abbreviation for “Read-Only Memory”) and/or a SSS device (abbreviation for “Solid-State Storage”) or the like.

The control unit 30 may further comprise input/output interfaces for signal communication S with at least the blower unit 10, the sensor units 22, 23 and 24 and the motion sensor unit 21. The control unit 30 and thus the fume extraction device 1 may also be configured for signal communication S with the hob 2 via communication module 2.3 of the hob 2 and a corresponding communication module or interface of the fume extraction device 1 (not illustrated in FIG. 1 for the sake of clarity). The signal communication S may be a wired signal communication or preferably a wireless signal communication, for example via infrared communication technology.

The control unit 30 may be further configured for querying or may query operating status data of the at least one cooking unit 2.1 of the hob 2.

According to the present invention, the control unit 30 is configured to activate and/or deactivate and/or variably control the blower unit 10 in an automatic mode dependent on the detected at least one parameter P. Additionally, or alternatively, the control unit 30 is configured to be set into such an automatic mode, preferably with the consequence to enable the control unit 30 to activate and/or deactivate and/or variably control the blower unit 10 in the automatic mode dependent on the detected at least one parameter P.

In other words, the control unit 30 is configured or can be set into a condition, in dependence on or dependent on the at least one parameter P, to execute at least one operation or at least one of the following on the blower unit 10: activating, deactivating and/or variably controlling.

According to a particularly preferred solution and with regard to the example of the fume extraction device 1 as illustrated in FIG. 1, the control unit 30 is configured to activate and/or deactivate and/or variably control the blower unit 10 in the automatic mode dependent on the detected motion data MD.

The automatic mode is preferably an autarkic or autonomous operating mode of the fume extraction device 1 in at least partially a closed-loop configuration, preferably without need of a user input. The automatic mode allows an independent activation and/or deactivation and/or control and/or regulation of the blower unit 10, with respect to the fume extraction device 1, depending on at least one detected parameter P or a plurality of detected parameters P as disclosed herein.

The control unit 30 may further be configured, for example, to determine, preferably calculate, a future control, i.e. a future control process or operation of the blower unit 10 from at least one detected parameter P, preferably detected over a past predetermined time interval.

The control unit 30 may be configured to calculate at least one control signal S for variably controlling the blower unit 10 as a function of the detected at least one parameter P or preferably several parameters such as temperature, humidity, compound or concentration of compounds, smoke (for example in case of fire), carbon dioxide (for example in case of fire), and/or, in general, air quality.

It is further possible that the control unit 30 is configured to calculate the at least one control signal S for variably controlling the blower unit 10 as a function of detected motion data MD of a user of the motion sensor unit 21 of the sensor system 20. Hence, the fume extraction device 1 is able to recognize the presence or absence of a user at least in the proximity of the hob 2 and/or the fume extraction device 1 and being operated accordingly considering information related to the user in form of motion data MD. With such information, the fume extraction device 1 may be differently operated than to set it into an automatic mode.

The present invention provides a fume extraction device 1 that is configured and/or equipped with components and elements which allow an operation of the fume extraction device 1 in an automatic mode. In other words, the fume extraction device 1 according to the present invention can be operated or is operated in a closed loop configuration with regard to the variably control of the blower unit 10, i.e. preferably the propeller 10.1 of the blower unit 10 dependent on the detected parameter P and preferably the detected motion data MD of a user. Hence, the propeller 10.1, i.e. the rotational speed of the propeller can be adjusted accordingly and preferably automatically taking into consideration conditions of the air being detected and evaluated by several different types of sensor units 22, 23, 24.

During a cooking process, the fume extraction device 1 according to the present invention is preferably configured to detect several parameters P such as humidity, temperature and/or specific compounds or concentration of compounds, preferably at least continuously, and in turn to control the blower unit 10 accordingly, preferably in a more or less autonomous manner. Hence, the quality of the air is improved until at least one of the detected at least one parameters P reaches a target value or is in a range of target values (for example, a valid range of temperature and/or humidity). Again, this kind of configuration of the fume extraction device 1 may be established only after the respective activation of the automatic mode dependent from the motion data MD, as previously explained.

The fume extraction device 1 according to the present invention can further comprise a user interface unit 40 or is configured for connection with a user interface unit 40, preferably via a wired signal communication S or more preferably via a wireless signal communication S, for example via infrared communication technology.

The user interface unit 40 may be configured to at least initially activate and/or finally deactivate the automatic mode of the fume extraction device 1, preferably dependent on operating status data of the blower unit 10, i.e. the propeller 10.1 and/or the detected motion data MD and/or the detected at least one parameter P. In other words, the automatic mode of the fume extraction device 1 may initially be activated or set by a user by means of operating a control element such as a pushable button or a knob icon on a touch screen.

The present invention thus follows a holistic approach in the provided fume extraction device 1, according to which at least one or preferably several parameters P, more preferably temperature and humidity parameters P, detected by sensor units 22, 23, 24 and representing the state of the environment of the hob 2, are used to operate the fume extraction device 1 in an automatic mode independently of a user input.

The present invention is described in further detail below with respect to a first method and a second method of operating the fume extraction device 1.

FIG. 2 illustrates a flowchart of a first example of the method according to the invention.

According to the first example, a method of operating a fume extraction device 1 for a hob 2 with at least one cooking unit 2.1, preferably a fume extraction device 1 as disclosed herein according to which the fume extraction device 1 preferably comprises a blower unit 10, wherein the blower unit 10 is configured for variably controlling via at least one control signal S, wherein the fume extraction device 1 comprises a sensor system 20 with at least one sensor unit 22, 23, 24 being configured for detecting at least one parameter P being in connection with the hob 2, and wherein the fume extraction device 1 comprises a control unit 30 being configured for controlling the blower unit 10 via the at least one control signal S.

In view of the above description of the components and elements of the fume extraction device 1, no further description will be made in the course of the description of the method in the following in order to avoid repetition.

Assuming that a cooking process on the hob 2 takes place or has been started, the method for operating the fume extraction device 1 is initiated or started in phase S10 according to which a user initially activates or sets the automatic mode of the fume extraction device 1 by means of operating a control element on a user interface unit 40 such as a pushable button on a haptic control panel or on a knob icon on a touch screen of the user interface unit 40.

In phase S20, the method can comprise detecting of the at least one parameter P by the at least one sensor unit 22, 23, 24.

Hence, parameters P like temperature, humidity and/or compounds or concentrations of compounds, are detected by the sensor units 22, 23, 24 in order to determine an operating status of the cooking process and/or the at least one cooking unit 2.1 of the hob 2.

In a further phase S30, motion data MD of a user can be detected additionally in order to further consider the presence or absence of a user in the course of the further course of the cooking process when operating the fume extraction device 1.

In phase S40, the method comprises activating the blower unit 10, i.e. the motor 10.2 and thus the propeller 10.1 with corresponding rotational speed, by the control unit 30 in order to provide an optimized suction effect.

Activating the blower unit 10 is preferably realized at least when the detected at least one parameter P such as temperature and/or humidity, has exceeded a target value, and/or in dependence of a change of the detected at least one parameter P and/or in dependence of a change of the detected motion data MD of a user at least over a time period.

The target value may be, for example, a predetermined or a calculated target value, and/or the time period may be, for example, a predetermined or a calculated time period. Hence, the target value may be a temperature value, a humidity value and/or a distance of the user towards the hob 2 (see FIG. 1) or the like.

Thus, more or less an automatic activation of the fume extraction device 1 in the automatic mode takes place only when preferably the air quality is in an appropriate contaminated condition. There is no need for further input of the user, for example.

With preferably the detected at least one parameter P or preferably several parameters P as disclosed herein, the method comprises in phase S50 variably and preferably automatically controlling the blower unit 10 by the control unit 30 via at least one control signal S in the automatic mode dependent on the detected at least one parameter P and, preferably in addition, on the detected motion data MD.

The rotational speed of the motor 10.2 and thus the propeller 10.1 is adjusted accordingly and in relation to detected parameters P and preferably detected motion data MD. Due to the sensor system 20, the fume extraction device 1 is configured to comprehensively detect the conditions of the air quality and variably control in more or less an autonomous manner the blower unit 10.

In phase S60, the method can comprise deactivating the blower unit 10, preferably when at least one detected parameter P or preferably at least two detected parameters P such as temperature and humidity have fallen below a target value.

Hence, the method is configured to more or less automatically deactivate the blower unit 10 once the air quality has reached a target value and/or a criterion, preferably for a predetermined time period, that allows deactivation of the blower unit 10.

It is possible that after deactivation of the blower unit 10 the fume extraction device 1 remains in a stand-by mode and being configured or being able to detect at least one parameter P once the hob 2. As soon as the hob 2 is reactivated and thus a new cooking process is started, automatic activation of the blower unit 10 can take place again by the method for operating the fume extraction device 1 according to the present invention.

The controlling of the blower unit 10 can be realized via transmitting at least one control signal S from a user interface unit 40 and/or from the control unit 30 and setting the automatic mode dependent on operating status data of the blower unit 10 and/or the detected motion data MD and/or the detected at least one parameter P.

It is further possible that the method comprises establishing a connection with the hob 2, preferably via a wired signal communication S or more preferably via a wireless signal communication S and querying of operating status data of at least one cooking unit 2.1 of the hob 2 to be considered for variable controlling the blower unit 10 via the control unit 30.

It is understood that at least two phases of the method according to the first example of the present invention may also be carried out at least partially in parallel and/or simultaneously.

FIG. 3 illustrates a flowchart of a second example of the method according to the invention.

According to the second example, a method of operating a fume extraction device 1 for a hob 2 with at least one cooking unit 2.1, preferably a fume extraction device 1 as disclosed herein according to which the fume extraction device 1 preferably comprises a blower unit 10, wherein the blower unit 10 is configured for variably controlling via at least one control signal S, wherein the fume extraction device 1 comprises a sensor system 20 with at least one sensor unit 22, 23, 24 being configured for detecting at least one parameter P being in connection with the hob 2, and wherein the fume extraction device 1 comprises a control unit 30 being configured for controlling the blower unit 10 via the at least one control signal S. Moreover, at least one motion sensor unit 21 is provided, being configured for detecting a user's motion data MD, the user moving around or staying in close vicinity of the hob 2 and/or the fume extraction device. “Motion data” in the context of the present invention may include a user's motion profile, which may include a plurality of single motion data MD.

In view of the above description of the components and elements of the fume extraction device 1, no further description will be made in the course of the description of the method according to the second example in the following in order to avoid repetition.

The method for operating the fume extraction device 1 according to the second example is initiated or started by S100. By this terminator box S100 also a final stage of the flowchart of the second example is formed, said final stage particularly being a starting point for a following operating process.

In contrast to phase S10 of the first example, as described above, according to which a user initially activates or sets the automatic mode of the fume extraction device 1, the process according to the flowchart of FIG. 2 comprises an initial process step S110 following the terminator box S100, which initial process step S110 is defined by a reading of motion data MD provided by motion sensor unit 21. Said motion sensor unit 21 is particularly a Time of Flight (ToF) sensor as it is known from the prior art. Process step S110 is itself formed by a sub-routine and will be described further down below with reference to FIG. 4.

If during evaluation of the received motion data MD it turns out, by decision box S120, that a human, i.e. a user of the cooking equipment 1, 2, is performing or starting a cooking process using the hob 2, the process is continued, following arrow “Y”, with process step S130, during which sensor signals S, sourcing from temperature sensor 22, humidity sensor 23 and VOC sensor 24, are retrieved. In the other case, i.e. no user “ready to cook” is identified, the routine returns to process step S110, following arrow “N” and closing the loop including boxes S110 and S120.

By process step S150, the query results of data retrieval during step S130 are evaluated and, if induced by results indicating particular conditions, e.g. in case of modifications compared to earlier conditions, at least one parameter for driving the blower unit 10, in particular a power level, is adjusted in order to attune to the modified conditions related to temperature, humidity and/or VOC level or amount. The process is continued with process step S130, thereby closing the loop including flowchart boxes S130 to S150. During the course of said loop, i.e. between process steps S130 and S150, repeatedly status check of the related cooking process is performed by decision box S140, i.e. getting an answer to query “cooking finalized?”, with the consequence of staying within said loop, i.e. continuing with process step S150, only in the case that the cooking process is continued (arrow “N”). This status check may be performed by repeatedly checking the motion data MD, as previously explained, or by checking any respective manual input provided by the user, who also may be empowered to break the loop by stepping out at S140 and following arrow “Y” towards terminator box S100.

As indicated above, the sub-routine according to process step S110 will be described now with reference to FIG. 4. The sub-routine starting with terminator box S200, which may be considered as being congruent with terminator box S100 of the entire process according to the second example, provides for an initial process step S210, in which motion data MD from motion sensor unit 21 are retrieved and information about a user's distance to hob 2 and/or to fume extraction device 1 is evaluated. As long as by decision box S220 the query “Distance not more than 150 cm?” will be answered by “no”, the process will return to process step S210, following arrow “N”. This query is considered as an elimination of “noise” for a person just walking around without any intention to start a cooking process. In the opposite case, i.e. if the query of decision box S220 will be answered by “yes”, the process is continued with process step S230, following arrow “Y”. In this case, which includes some likelihood of a user to be in preparation of a cooking process, a timer will be started under process step S230, in order to increase the hit probability for the interpretation of the user's preparedness to start cooking. If the duration of the user's distance of at most 150 cm will exceed 3 sec, evaluated by decision box S240, the sub-routine will end with an activation of the automatic mode according to process step S250, following arrow “Y”, which means a continuation of the entire process by coupling into process step S130 according to flowchart of FIG. 3. In the opposite case, i.e. when answering the query of decision box S240 with “no”, the sub-routine will be continued by closing a loop returning to process step S210, following arrow “N”.

Any one of the methods according to the present invention, as previously described, may be, at least in part, a computer-implemented method realized via at least one algorithm. The present invention can be transferred to at least one computer program product as regards preferably the methods or at least partially the methods according to the present invention.

Preferably, the present invention also claims protection for the subject matter and the features of the sub-claims independently of the claims referred to.

### LIST OF REFERENCE SIGNS

1 fume extraction device
2 hob
2.1 cooking unit
2.2 vessel
2.3 communication module
10 blower unit
10.1 propeller of the blower unit
10.2 motor
20 sensor system
21 motion sensor unit
22 temperature sensor
23 humidity sensor
24 VOC sensor
30 control unit
40 user interface unit
P parameter
S signal
Y “yes”
N “no”
S10 . . . . S250 flowchart symbols

1. A fume extraction device, configured to draw in cooking fumes of a hob having at least one cooking unit, wherein the fume extraction device comprises a blower unit, wherein the blower unit is configured for being variably controlled by means of or in response to at least one control signal,
wherein the fume extraction device is connected to or communicates with or comprises a sensor system with at least one sensor unit, which comprises a temperature sensor, a humidity sensor and/or a VOC sensor, for example a TVOC sensor, the at least one sensor unit being configured for detecting at least one parameter, being in connection with the hob,
wherein the fume extraction device comprises or communicates with a control unit, wherein
the control unit is configured for controlling the blower unit via the at least one control signal and to activate and/or deactivate and/or variably control the blower unit in an automatic mode dependent on the detected at least one parameter,
and/or
the sensor system comprises a motion sensor unit being configured for detecting motion data of a user, wherein the control unit is configured to activate and/or deactivate and/or variably control the blower unit in the automatic mode dependent on the detected motion data, dependent on motion data indicating the user's presence and/or movement in or within a predetermined vicinity of the fume extraction device and/or of the hob.

2. The fume extraction device according to claim 1,
wherein the control unit is configured to calculate the at least one control signal for variably controlling the blower unit as a function of the detected at least one parameter and/or as a function of the detected motion data.

3. The fume extraction device according to claim 1,
wherein the control unit is configured to at least activate and/or deactivate the automatic mode, dependent on operating status data of the blower unit and/or the detected at least one parameter and/or the detected motion data.

4. The fume extraction device according to claim 1,
wherein the fume extraction device comprises a user interface unit or is configured for connection with a user interface unit, via a wired signal communication or via a wireless signal communication, wherein the user interface unit is configured to at least activate and/or deactivate the automatic mode, dependent on operating status data of the blower unit and/or the detected at least one parameter and/or the detected motion data.

5. The fume extraction device according to claim 1,
wherein the automatic mode is activatable based on detected motion data, based on a plurality of detected motion data, based on a user's motion profile, which is interpretable by the control unit as a user's execution of or intention to perform a cooking process.

6. The fume extraction device according to claim 5,
wherein the motion data providing a basis for the interpretation of the user's execution of or intention to perform a cooking process include a user's stay at a distance to the fume extraction device and/or to the hob, wherein the user's distance is equal to or lower than a predetermined distance value, and wherein the user's stay is equal to or longer than a predetermined stay time.

7. A method of operating a fume extraction device, for drawing in cooking fumes of a hob having at least one cooking unit, a fume extraction device according to claim 1,
wherein the fume extraction device comprises a blower unit, wherein the blower unit is variably controlled by means of or in response to at least one control signal, wherein the fume extraction device is connected to or communicates with or comprises a sensor system with at least one sensor unit being configured for detecting at least one parameter, being in connection with the hob, and wherein the fume extraction device communicates with or comprises a control unit, which controls the blower unit, the method comprising:
a. Detecting the at least one parameter by the at least one sensor unit;
b. Variably controlling the blower unit by the control unit via the at least one control signal in an automatic mode dependent on the detected at least one parameter,
and/or
a′. Detecting at least one motion data of a user by a motion sensor unit of the sensor system;
b′. Activating an automatic mode for an automatic control of the fume extraction device and/or variably controlling the blower unit by the control unit via the at least one control signal in an automatic mode dependent on the detected motion data (MD), dependent on motion data indicating the user's presence in or within a predetermined vicinity of the fume extraction device and/or of the hob.

8. The method according to claim 7, further comprising:
Activating and/or deactivating the blower unit by the control unit, at least when the detected at least one parameter has exceeded or has fallen below a target value, and/or in dependence of a change of the detected at least one parameter and/or in dependence of a change of detected motion data of a user at least over a time period,
wherein the target value is a predetermined or a calculated target value, and/or the time period is a predetermined or a calculated time period.

9. The method according to claim 7, further comprising:
Comparing the detected at least one motion data with at least a further detected motion data and/or comparing the detected at least one parameter with at least a further detected at least one parameter; and
Calculating a motion deviation indicator of the compared detected motion data and the further detected motion data and/or calculating a parameter deviation indicator of the compared detected at least one parameter and the further detected at least one parameter.

10. The method according to claim 9, further comprising:
Generating at least one control signal dependent on the calculated motion deviation indicator and/or the calculated parameter deviation indicator; and
Variably controlling the blower unit by the control unit via the generated at least one control signal, in the automatic mode.

11. The method according to claim 7, wherein the detection of the motion data and/or the detection of the at least one parameter is or are monitored, the monitoring comprising:
Querying operating status data of the motion sensor unit and/or the at least one sensor unit;
Sending at least one test signal from the control unit to the motion sensor unit and/or to the at least one sensor unit; and/or
Returning at least one test signal from the motion sensor unit and/or from the at least one sensor unit to the control unit.

12. The method according to claim 7, further comprising:
Validating the detected at least one motion data and/or the detected at least one parameter, with a further detected motion data and/or a further detected at least one parameter; and
Adapting the at least one control signal dependent on the validated detected motion data and/or the validated detected at least one parameter.

13. The method according to claim 7, further comprising:
Setting the automatic mode dependent on operating status data of the blower unit and/or the detected at least one parameter and/or the detected motion data, following a transmission of at least one control signal from a user interface unit to the control unit.

14. The method according to claim 7, wherein the automatic mode is activated based on detected motion data, based on a plurality of detected motion data, based on a user's motion profile, which is interpretable by the control unit as a user's execution of or intention to perform a cooking process.

15. A system including a fume extraction device and a hob or a combination apparatus comprising a hob and a fume extraction device, wherein the fume extraction device is configured according to claim 1,
wherein the fume extraction device is integrated at least partially into the hob or arranged opposite the hob and/or arranged at a distance from the hob laterally next to the hob.

16. The system or the combination apparatus according to claim 15, wherein the automatic mode is only activated or activatable following or in dependency of a touch or activation of a key or control element of the fume extraction device or of the hob.

17. A system including a fume extraction device and a hob or a combination apparatus comprising a hob and a fume extraction device, wherein the fume extraction device is configured is configured to be operated by the method according to claim 7,
wherein the fume extraction device is integrated at least partially into the hob or arranged opposite the hob and/or arranged at a distance from the hob laterally next to the hob.
